(19) United States
(12) Patent Application Publication
(10) Pub. No.: US 2011/0057896 A1
(43) Pub. Date: Mar. 10, 2011

(54) APPARATUS AND METHOD FOR CONTROLLING MOBILE TERMINAL

(75) Inventor: Kun-Woo Baek, Gyeonggi-do (KR)

(73) Assignee: SAMSUNG ELECTRONICS CO., LTD., Gyeonggi-Do (KR)

(21) Appl. No.: 12/875,189

(22) Filed: Sep. 3, 2010

(30) Foreign Application Priority Data
Sep. 4, 2009 (KR) 10-2009-0083625

(51) Int. Cl. G06F 3/041

(52) U.S. Cl. 345/173

(57) ABSTRACT

A method for controlling an input touch in a mobile terminal includes: upon generation of a touch input on a touch screen, displaying a pointer at coordinates recognized by the touch screen with respect to the generated touch input and displaying a pointer-controller comprising the pointer, determining whether the pointer-controller is moved, and moving and displaying the pointer according to the movement of the pointer-controller, upon generation of an input indicating completion of the pointer to a desired location, recognizing that the touch input has been generated at the desired location, and performing an operation corresponding to the recognized touch input.

### CLAIM OF PRIORITY

This application claims the benefit under 35 U.S.C. §119(a) of a Korean Patent Application filed in the Korean Intellectual Property Office on Sep. 4, 2009 and assigned Serial No. 10-2009-0083625, the entire disclosure of which is hereby incorporated by reference.

### BACKGROUND OF THE INVENTION

1. Field of the Invention

The present invention generally relates to an apparatus and method for controlling a mobile terminal, and more particularly, to an apparatus and method for controlling a mobile terminal by correcting an input error on a touch screen.

2. Description of the Related Art

Generally, a mobile terminal refers to a communication apparatus by which a user can perform communication and exchange data while on the move. Recently, in line with an era of digital convergence, various and useful functions have been realized on the mobile terminal. For example, using the mobile terminal, the user can now enjoy Audio-On-Demand (AOD) and Video-On-Demand (VOD) services, talk over the telephone through video communication while seeing a communication partner's face, or download and play a game. That is, mobile terminals are no longer being used solely for voice communication.

With the diversification of functions available in the mobile terminal, users come to find it necessary to control the mobile terminal more quickly and with greater ease of convenience. To this end, mobile terminal manufacturers have provided a display unit implementing a touch screen function to the users. There are several types of touch screen technology including capacitive overlay, resistive overlay, surface acoustic wave, a scheme using a transmitter, and a scheme using an infrared beam.

However, the mobile terminal having the touch screen has a drawback in that a frequent error can occur during recognition or operation of the touch screen. In particular, the capacitive overlay touch screen recognizes a touch of a user's body (for example, a finger) as an input thereof. In this scheme, there may occur an error caused by a difference between the timing at which the user's finger touches the touch screen and the timing at which the touch is recognized by the touch screen (an error in recognition of an input), an error involving a user's viewpoint with respect to the touch screen and the position of the touch screen, or an error resulting from a variation in inclination of the finger touching the touch screen. The main cause of the error in the capacitive overlay touch screen arise from discrepancy is that the user thinks the finger's touch point as a touch input point, whereas the touch screen recognizes a point indicated by two-dimensional (2D) coordinates (X, Y) as the user touch input point through internal coordinates detection algorithm and correction algorithm.

Considering the popularization of the mobile terminal using the touch screen, it is necessary to correct a recognition error of an input (or an input error). Thus, there is a need for providing an accurate touch input when using the touch screen.

### SUMMARY OF THE INVENTION

An aspect of the present invention is to address at least the above problems and/or disadvantages and to provide at least the advantages described below. Accordingly, an aspect of the present invention is to provide an apparatus and method for allowing an accurate touch input using a touch screen.

According to an aspect of the present invention, a method for controlling a mobile terminal includes upon generation of a touch input on a touch screen, displaying a pointer at coordinates recognized by the touch screen with respect to the generated touch input and displaying a pointer-controller including the pointer, moving and displaying the pointer according to the movement of or within the pointer-controller, upon generation of an input of the pointer, recognizing that the touch input has been generated at a desired point or location, and performing an operation corresponding to the recognized touch input.

According to another aspect of the present invention, an apparatus for controlling a mobile terminal includes a touch screen for sensing generation of a touch input from a user and a controller for performing control operations including: upon generation of a touch input on a touch screen, displaying a pointer at coordinates recognized by the touch screen with respect to the generated touch input, and displaying a pointer-controller including the pointer, determining whether the pointer-controller is moved, and if so, moving and displaying the pointer according to the movement of the pointer-controller, and upon generation of an input of the pointer, recognizing that the touch input has been generated at a desired location or item and performing an operation corresponding to the recognized touch input.

### BRIEF DESCRIPTION OF THE DRAWINGS

The above and other features and advantages of an exemplary embodiment of the present invention will be more apparent to those skilled in the art from the following detailed description taken in conjunction with the accompanying drawings, in which:

FIG. 1 is a block diagram of a mobile terminal according to an embodiment of the present invention;

FIG. 2 is a flowchart illustrating a process of controlling a mobile terminal by using a touch screen according to an embodiment of the present invention; and

FIGS. 3A through 5D are exemplary diagrams for describing a process of controlling a mobile terminal by using a touch screen according to an embodiment of the present invention.

### DETAILED DESCRIPTION OF THE INVENTION

Hereinafter, an exemplary embodiment of the present invention will be described in detail with reference to the accompanying drawings.

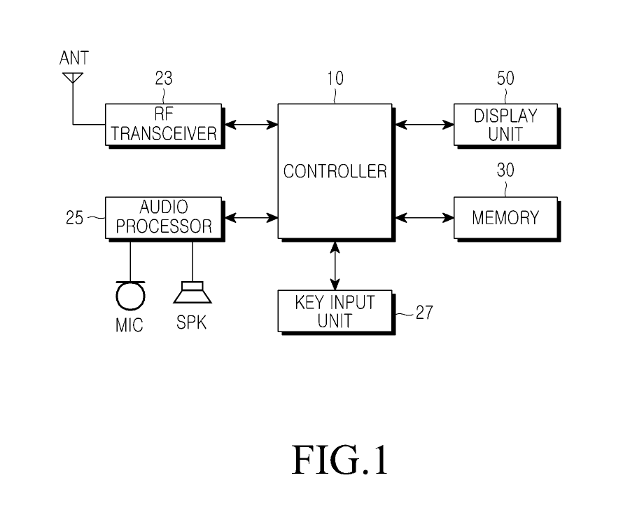

FIG. 1 is a block diagram of a mobile terminal according to an embodiment of the present invention.

As shown, a key input unit 27 includes keys for inputting number and character information and function keys for setting various functions.

A radio frequency (RF) transceiver 23 performs a communication function of the mobile terminal and includes an RF unit and a modulator/demodulator (MODEM). The RF unit includes an RF transmitter for frequency up-converting and amplifying a transmission signal and an RF receiver for low-noise amplifying a received signal and frequency down-converting the received signal. The MODEM includes a transmitter for coding and modulating a transmission signal and a receiver for demodulating and decoding a signal received from the RF unit. Alternatively, the RF transceiver 23 may be replaced with an RF module such as a WiFi module or a Bluetooth module.

An audio processor 25 may include a COder/DECoder (CODEC) which includes a data codec and an audio codec. The data codec processes packet data, and the audio codec processes an audio signal such as voice or a multimedia file. The audio processor 25 converts a digital audio signal received from the MODEM into an analog audio signal through the audio codec and reproduces the analog audio signal. Alternatively, the audio processor 25 converts an analog audio signal generated from a microphone into a digital audio signal through the audio codec and transmits the digital audio signal to the MODEM. The codec may be provided separately or included in a controller 10.

A memory 30 includes a Read Only Memory (ROM) and a Random Access Memory (RAM). The memory 30 may include a program memory and data memories to store programs for controlling general operation of the mobile terminal and data for booting.

A display unit 50 displays an image signal and user data on the screen or displays data associated with communication. The display unit 50 may employ a Liquid Crystal Display (LCD), an Organic Light Emitting Diode (OLED), or an Active Matrix Organic Light Emitting Diode (AM OLED). When the LCD, the OLED, or the AM OLED is embodied in a touch screen display, the display unit 50 may operate as an input unit for controlling the mobile terminal, together with the key input unit 27. Thus, the display unit 50 according to an embodiment of the present invention operates as an input unit for controlling the mobile terminal together with the key input unit 27 via a touch screen.

The touch screen according to an embodiment of the present invention may be a capacitive overlay touch screen, on a surface of which a special conductive metallic material is coated to form a transparent electrode and a specific amount of current flows. Thus, when a user touches the capacitive overlay touch screen, the touch screen recognizes a part in which the amount of current is changed, by using the capacitance of the user's body, to detect a touch position. Although the touch screen according to an embodiment of the present invention is assumed to be a capacitive overlay touch screen, it should be noted that other variety of touchscreen technologies know to those skilled in the art may be applied such as resistive touch screen, surface acoustic wave, optical imaging, coded LCD, etc.

The controller 10 controls the overall operation of the mobile terminal. The controller 10 according to an embodiment of the present invention displays a pointer-controller 100 upon identifying (sensing) a touch input from the user to the touch screen of the display unit 50, determines that the touch input is generated at a position where a pointer 110 is located. Upon generation of an input after the pointer-controller 100 and the pointer 110 indicated by the user are moved, the controller 10 controls the mobile terminal to operate according to the touch input.

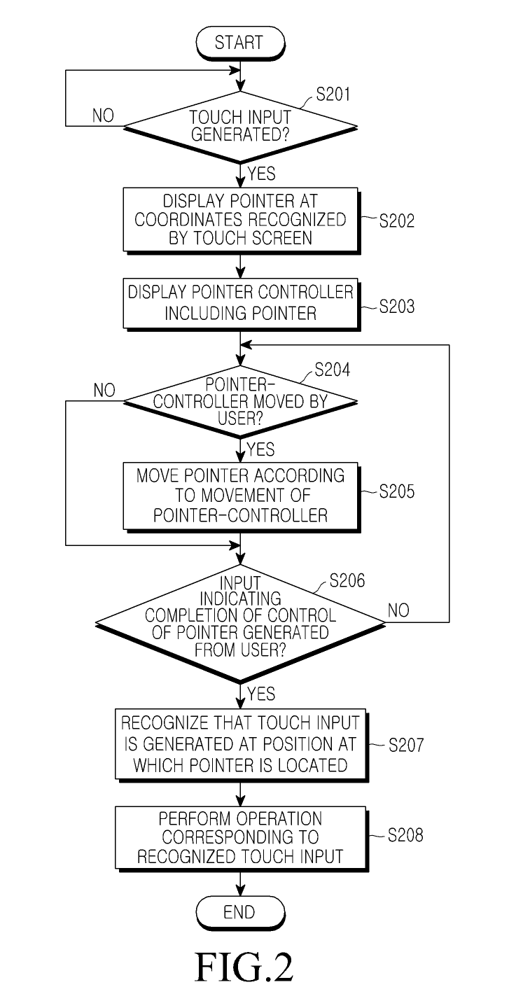

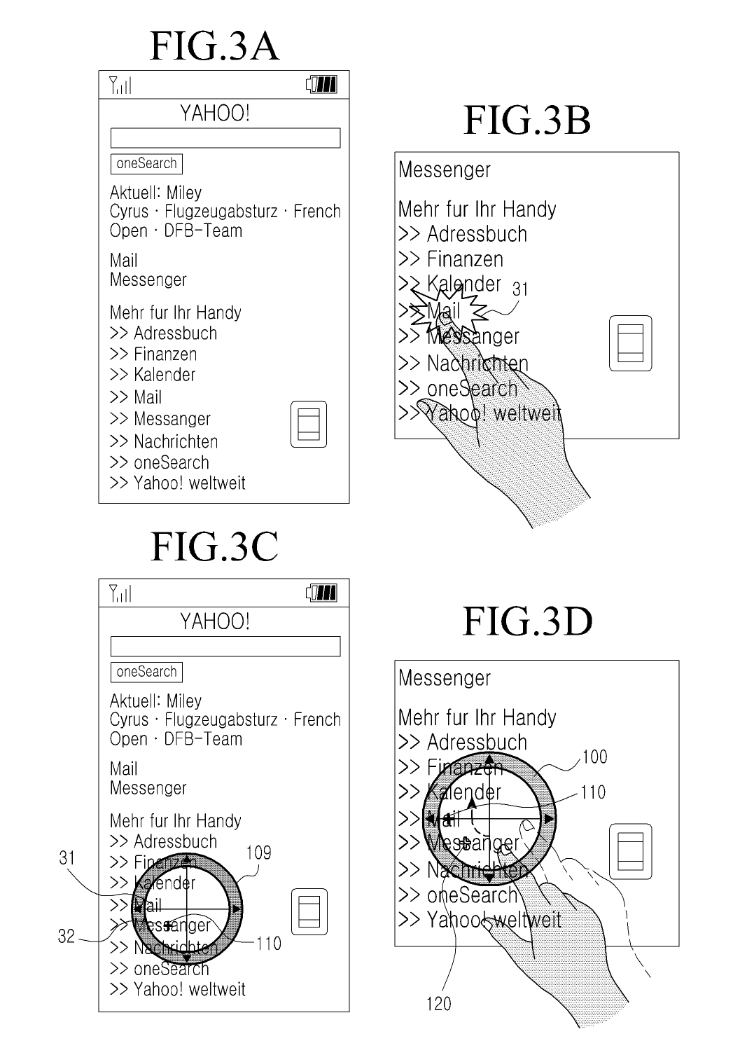

FIG. 2 is a flowchart illustrating a process of controlling the mobile terminal by using the touch screen according to an embodiment of the present invention, and FIGS. 3A through 5D are exemplary diagrams associated with FIG. 2. A description will now be made of an embodiment of the present invention with reference to FIGS. 2 through 5D.

The controller 10 determines whether a touch input to the touch screen is generated in step S201, displays a pointer at coordinates recognized by the touch screen in step S202 if it is determined that the touch input to the touch screen is generated, and displays the pointer-controller including the pointer in step S203.

FIG. 3A shows an example where various information is displayed on a display of the mobile terminal, for example, when the Internet is used with Wireless Application Protocol (WAP). On the touch screen as shown in FIG. 3A, if the user makes a touch input to the touch screen (for example, a single touching input or a tapping input for an item ‘Mail’ 31) to select the Mail item 31 as shown in FIG. 3B, the controller 10 displays the pointer 110 (indicated by dark cross) at coordinates actually recognized by the touch screen (for example, an input point sensed by the touch screen as x and y coordinates of the display unit 50) as shown in FIG. 3C.

Since the user's desired touch input point and the input point recognized by the touch screen are not the same, the user can easily recognize such a difference based on the display of the pointer 110 at coordinates actually recognized by the touch screen.

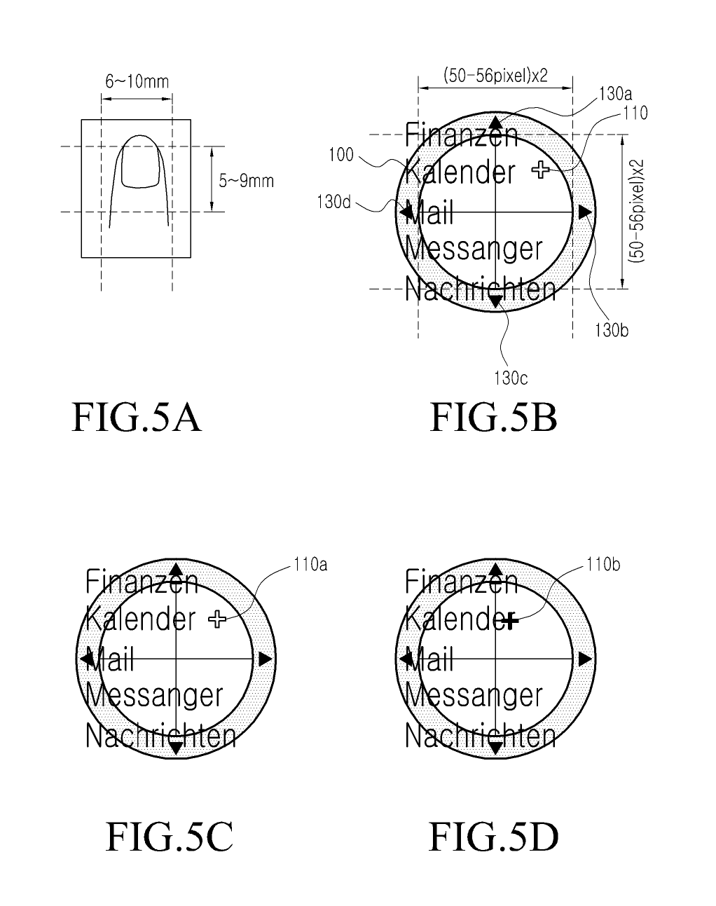

In addition, the controller 10 according to an embodiment of the present invention displays the pointer 110 as a pointer 110b whose color (dark cross) is changed to the color of the pointer 110 as shown in FIG. 5D when the pointer 110 is positioned at a predetermined item (for example, an item ‘Kalender’ in the WAP page) that can be selected by the user. However, if the pointer 110 is not positioned at the predetermined item, the controller 10 displays the pointer 110 as a pointer 110a whose color (white cross) is the same as the color of the pointer 110 as shown in FIG. 5C.

Thereafter, the controller 10 displays the pointer-controller 100 including the pointer 110 therein. Referring to FIG. 3C, although the user makes the touch input to the touch screen to select the Mail item 31, the touch input point recognized by the touch screen is in the proximity of an item ‘Messenger’ 32 as indicated by the pointer 110. As such, according to conventional art, even if the user makes a touch input to the touch screen to select the Mail item 31, the Messenger item 32 may be selected. Here, to display the pointer-controller 100, the present invention may enlarge the pointer-controller 100 by a predetermined size or more (for example, four times) based on an area where the touch input is sensed and display the enlarged pointer-controller 100 as shown in FIG. 5B according to a modified embodiment of the present invention. That is, the area where the touch input is sensed, which is used as a base for enlarging and displaying the pointer-controller 100, is assumed to be an area of a user's finger. The area of the user's finger touching the touch screen may be assumed to have a size of 6-10 mm (width)×5-9 mm (length) as shown in FIG. 5A, but the width and the length may be changed by a manufacturer or the user. Accordingly, the present invention displays the pointer-controller 100 by enlarging each of the width and length of the area touched on the touch screen (for example, the area where the touch input is sensed) two times (that is, four times in terms of area) according to a modified embodiment of the present invention. Thus, the user can clearly see an error between the desired touch input point the user actually makes and the point recognized by the touch screen (coordinates on the display unit).

If the display unit 50 according to an embodiment of the present invention is assumed to have a resolution of 240×320 pixels, each of which has a dot pitch of 0.178 mm, the area where the touch input is sensed shown in FIG. 5A would occupy 56 pixels (10/0.178) in width to the maximum and 50 pixels (9/0.178) in length to the maximum. According to a modified embodiment of the present invention, the pointer-controller 100 displayed in step S203 may be set such that it may be automatically displayed upon generation of the touch input in step S201, may be displayed upon generation of a predetermined touch input (for example, a drag touch input in a particular direction) at a predetermined position of the touch screen, or may be displayed upon input of a predetermined key (for example, a predetermined function key) of the key input unit 27.

The pointer 110 displayed in step S202 and the pointer-controller 100 displayed in step S203 may be set to be displayed automatically upon execution of a particular operation mode of the mobile terminal which requires a precise touch input. For example, the pointer 110 and the pointer-controller 100 may be set such that, upon execution of a WAP browsing mode which requires a precise selection of a link item from among numerous link items, such as in the Internet, at least one of the pointer-controller 100 and the pointer 110 may be displayed.

Thereafter, the controller 10 determines whether the pointer-controller 100 is moved by the user in step S204, and controls the pointer 110 to be moved according to the movement of the pointer-controller 100 in step S205 if the pointer-controller 100 is moved.

According to an embodiment of the present invention, a user interface such as the pointer-controller 100 is provided to prevent an erroneous touch input to the touch screen. The pointer-controller 100 according to an embodiment of the present invention can be moved by the user, such that the user can move the pointer-controller 100 in a predetermined direction by touching and then dragging the pointer-controller 100 in the predetermined direction. For example, as shown in FIG. 3D, the user may touch and drag a predetermined portion (except for a control button to be described below) of the pointer-controller 100, thereby moving the pointer-controller 100 in a predetermined direction.

Referring to FIG. 3D, once it is determined that the pointer-controller 100 is moved by the user in the predetermined direction, the controller 10 according to an embodiment of the present invention moves the pointer 110 according to the movement of the pointer-controller 100 (for example, in a normal direction corresponding to the normal-direction movement of the pointer-controller 100 or in a reverse direction corresponding to the reverse-direction movement thereof) and displays the pointer 110.

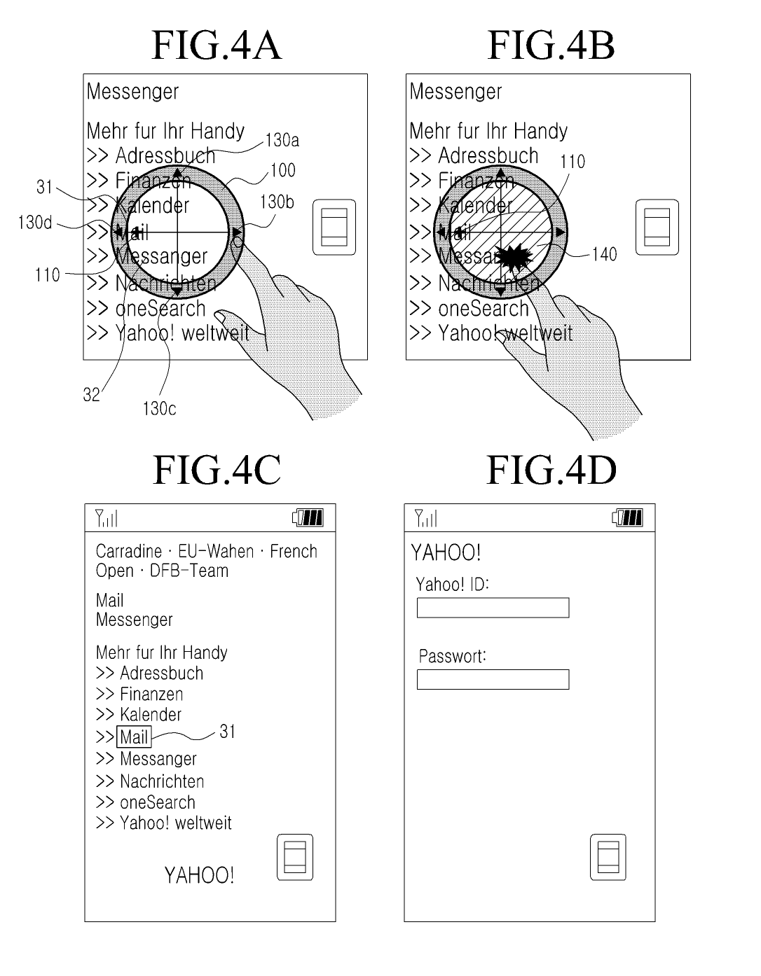

Referring to FIG. 4A, the pointer-controller 100 according to an embodiment of the present invention provides additional navigation control buttons 130a through 130d, thus allowing the user to more precisely control the position of the pointer 110 through input of a control button. Thus, if a touch input from the user is sensed at positions (or positions in proximity thereto) where the control buttons 130a through 130d are displayed, the controller 10 according to an embodiment of the present invention moves the position of the pointer 110 according to a control button for which the touch input is sensed. Herein, it is assumed that the control button 130a moves the pointer 110 up, the control button 130b moves the pointer 110 to the right, the control button 130c moves the pointer 110 down, and the control button 130d moves the pointer 110 to the left.

The controller 10 according to an embodiment of the present invention, after moving and displaying the pointer 110 according to the movement of the pointer-controller 100 or according to the input of a control button, may indicate a position of the pointer 110 which is initially recognized by the touch screen as shown in FIG. 3C using a pointer 120 as shown in FIG. 3D. Herein, it is assumed that the pointer 110 and the pointer 120 are differently displayed by using different colors or shapes.

Next, if it is determined that an input indicating completion of the control of the pointer 110 is generated from the user in step S206, the controller 10 determines that a touch input to the touch screen is generated at a position where the pointer 110 is currently located in step S207, and controls components to perform an operation corresponding to the touch input in step S208.

The user moves the pointer 110 to the Mail item 31 to make a touch input for a desired location or item (for example, ‘Mail’) in steps S202 through S205. Afterwards, the user needs to indicate completion of the control of the pointer 110 to inform the controller 10 that the Mail item 31 is the desired touch input item.

In an embodiment of the present invention, the input indicating the completion of the control (for example, movement) of the pointer 110 is assumed to be a double-touch input of a predetermined part inward from the pointer-controller 110 (for example, a concentric circle 140 in the pointer-controller 110) as shown in FIG. 4B.

However, according to a modified embodiment of the present invention, the input indicating the completion of the control of the pointer 110 may be a long-touch input of the predetermined part of the pointer-controller 110 or an input of a predetermined key among keys of the key input unit 27. If it is determined that the input indicating completion of the control of the pointer 110 is generated from the user in step S206, the controller 10 according to an embodiment of the present invention may indicate the generation to the user by applying a visual effect (e.g., a change in color) to the pointer-controller 100.

If it is determined that the input indicating completion of the control of the pointer 110 is generated from the user in step S206, the controller 10 identifies that the Mail item 31 has been selected as shown in FIG. 4C and accesses a server according to the selection of the Mail item 31 to receive and display a predetermined WAP page as shown in FIG. 4D.

Although the predetermined WAP page is accessed and the Mail item 31 is selected by way of example in an embodiment of the present invention, the user may more precisely and accurately use the mobile terminal (for example, select a menu for setting the mobile terminal) by using the pointer-controller 100 according to the embodiment of the present invention.

Note that the above-described methods according to the present invention can be realized in hardware or as software or computer code that can be stored in a machine readable recording medium such as a CD ROM, a RAM, thumbnail drive, a floppy disk, a flash storage, a hard disk, or a magneto-optical disk or downloaded over a network and stored as a non-transitory data on one of the aforementioned mediums, so that the methods described herein can be executed by such software using a general purpose computer, or a special processor or in programmable or dedicated hardware, such as an ASIC or FPGA. As would be understood in the art, the computer, the processor or the programmable hardware include memory components, e.g., RAM, ROM, Flash, etc. that may store or receive software or computer code that when accessed and executed by the computer, processor or hardware implement the processing methods described herein. In addition, it would be recognized that when a general purpose computer accesses code for implementing the processing shown herein, the execution of the code transforms the general purpose computer into a special purpose computer for executing the processing shown herein.

As is apparent from the foregoing description, when the user makes a touch input, the user can correct a difference between the user touch input point and an input point actually sensed by the touch screen, thereby allowing more accurate touch input.

While the invention has been shown and described with reference to a certain preferred embodiment thereof, it will be understood by those skilled in the art that various changes in form and details may be made therein without departing from the spirit and scope of the invention as defined by the appended claims and equivalents thereof.

What is claimed is:

1. A method for controlling a mobile terminal, the method comprising:
upon generation of a touch input on a touch screen, displaying a pointer-controller having a pointer at coordinates recognized by the touch screen with respect to the generated touch input;
in response to a movement within the pointer-controller, displaying the pointer corresponding to the movement;
upon generation of an input at a desired location, recognizing that the touch input has been generated at the desired location; and
performing an operation corresponding to the recognized touch input.

2. The method of claim 1, wherein the pointer-controller is displayed according to a predetermined touch input.

3. The method of claim 1, wherein the pointer-controller is displayed according to an input of a predetermined key of a key input unit.

4. The method of claim 1, wherein the pointer-controller is automatically displayed upon execution of a predetermined operation mode.

5. The method of claim 1, wherein the pointer-controller is displayed such that an area where the generated touch input is sensed is enlarged by a predetermined size for display.

6. The method of claim 1, wherein the pointer-controller comprises at least one navigation control button for controlling a movement of the pointer.

7. The method of claim 1, further comprising enlarging the pointer-controller by a predetermined size on the touch screen.

8. An apparatus for controlling a mobile terminal, comprising:
a touch screen for sensing a touch input; and
a controller for displaying a pointer-controller having a pointer at coordinates recognized by the touch screen with respect to the sensed touch input; in response to a movement within the pointer-controller, displaying the pointer corresponding to the movement; upon generation of an input at a desired location, recognizing that the touch input has been sensed at the desired location; and performing an operation corresponding to the recognized touch input.

9. The apparatus of claim 8, wherein the controller controls the pointer-controller to be displayed according to a predetermined touch input or according to an input of a predetermined key of a key input unit.

10. The apparatus of claim 8, wherein the controller controls the pointer-controller to be displayed according to an input of a predetermined key of a key input unit.

11. The apparatus of claim 8, wherein the controller controls the pointer-controller to be displayed automatically upon execution of a predetermined operation mode.

12. The apparatus of claim 8, wherein the controller controls the pointer-controller to be displayed such that an area where the touch input is sensed is enlarged by a predetermined size and then displayed.

13. The apparatus of claim 8, wherein the pointer-controller comprises at least one navigation control button for controlling a movement of the pointer.

14. The apparatus of claim 8, wherein the controller controls the touch screen to enlarging the pointer-controller by a predetermined size for a display.
